(19) United States
(12) Patent Application Publication
(10) Pub. No.: US 2008/0209704 A1
(43) Pub. Date: Sep. 4, 2008

(54) Lower Electrode Dressing Tool for Projection Welding

(76) Inventors: Kevin Veenstra, Decatur, AL (US); Jack Gray, Decatur, AL (US); Steve Rudd, Decatur, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/846,087

(22) Filed: Aug. 28, 2007

Related U.S. Application Data
(63) Continuation-in-part of application No. 11/231,157, filed on Sep. 20, 2005, now abandoned.

(51) Int. Cl. B23P 19/00

(52) U.S. Cl. 29/33 K; 29/56.5

(57) ABSTRACT

A lower electrode dressing tool for a projection welding machine is disclosed. The present invention includes a rotary dresser that refurbishes a projection welding lower electrode. The dresser utilizes the lower electrode's locating pin that stabilizes the dresser as its rotating cutting elements reshape and resurface the lower electrode. This allows for smoother and more accurate performance of the dresser.

### CROSS REFERENCE TO RELATED APPLICATIONS

This application is a Continuation-in-Part of U.S. patent application Ser. No. 11/231,157 titled “Lower Electrode Dressing Tool for Projection Welding” filed on Sep. 20, 2005 (now abandoned).

### BACKGROUND OF INVENTION

1. Field of the Invention

The invention relates generally to welders. More specifically, the present invention relates to an improved dresser for a projection welding lower electrode.

2. Background Art

Projection welding is a variation of traditional spot welding. However, its process and applications are very distinct and unique. Projections are designed in a designated part of the workpieces to be welded together. These projections act as current concentrators for electrodes on the welding machines. When the two workpieces are mated together, these projections are the high points that first make contact. As the power is cycled, the projections simultaneously carry the current and are welded. The force and current that is applied from the welding machine is concentrated in a small contact area.

The process is well established and is applicable mainly to low carbon or micro-alloyed steels. The process is widely used on sheet metal assemblies in automotive and white goods industries for both sheet joining and attaching nuts and studs. Steel wire shopping carts, wire mesh, wire racks, and other crosswire products are all projection welding. Nuts and bolts are often welded to other metal parts by projection welding.

The advantages of projection welding include its versatility, the speed and ability to automate, the ability to make a number of welds simultaneously and minimization of marking on one side of joints in sheet materials. The weld is typically completed in a single shot within milliseconds. FIG. 1 shows a perspective view of a projection welder 10. The welder 10 includes a frame 12 that supports the workpieces being fed through the welder 10. The welding is done by an upper electrode element 14 and a lower electrode element 16 with its locating pin 18 that come together to apply force and current to make the weld.

During the welding process, the lower electrode eventually becomes inoperable due to deformation from the heat and pressure. The electrodes have to be replaced and refurbished for further use. This requires that production activities involving the welding machine are idle while the electrode is replaced or refurbished. It would be advantageous to refurbish the lower electrode insitu with a dresser that minimizes the interruption to production involving the welding machine.

### SUMMARY OF INVENTION

In some aspects, the invention relates to a dresser for refurbishing a projection welding lower electrode, comprising: a rotating cutting adapter that comprises a plurality of cutting elements; and a recessed opening within the interior of the cutting adapter that seats the adapter against a locating pin of the projection welding lower electrode in order to stabilize the rotating cutting mechanism.

In other aspects, the invention relates to a dresser for refurbishing a projection welding electrode, comprising: a rotating cutting adapter that comprises a plurality of cutting elements; means for seating the cutting elements against the projection welding electrode; and means for stabilizing the rotating cutting adapter against a locating pin of the projection welding electrode.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a perspective view of a prior art projection welder with upper and lower electrodes.

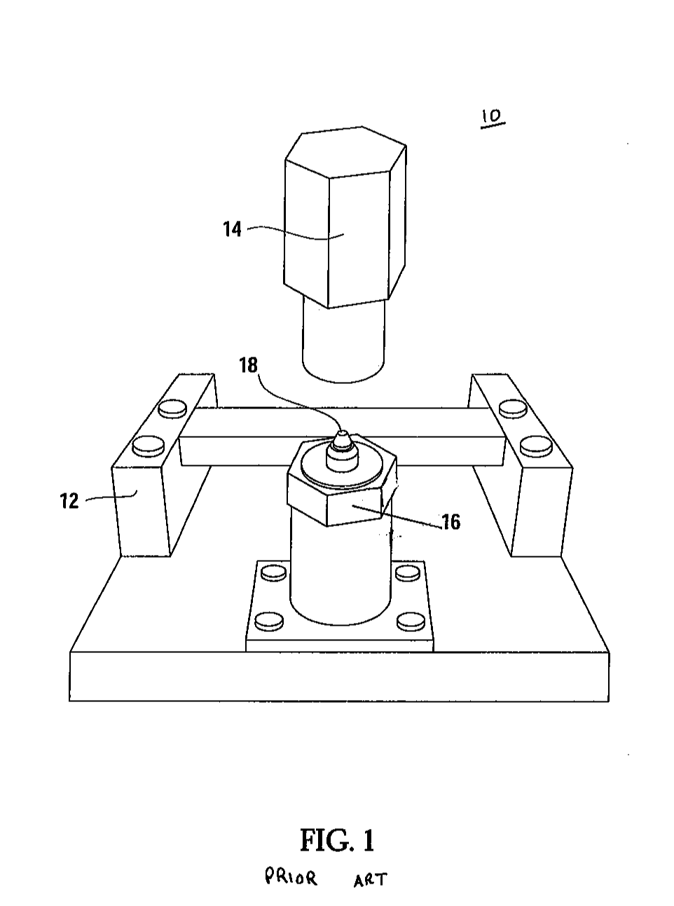

FIG. 2 shows a perspective view of a lower electrode dresser in accordance with one embodiment of the present invention.

FIG. 3 shows an exploded perspective view of a lower electrode dresser in accordance with one embodiment of the present invention.

FIGS. 4a and 4b show exploded frontal and side views respectively of a lower electrode dresser in accordance with one embodiment of the present invention.

FIG. 5 shows a perspective view of a cutting adapter for a lower electrode dresser in accordance with one embodiment of the present invention.

FIGS. 6a and 6b show cross-sectional overhead and side views respectively of a cutting adapter for a lower electrode dresser in accordance with one embodiment of the present invention.

### DETAILED DESCRIPTION

A lower electrode dressing tool for a projection welding machine is disclosed. The present invention includes a rotary dresser that refurbishes a projection welding lower electrode. The dresser utilizes the lower electrode's locating pin that stabilizes the dresser as its rotating cutting elements reshape and resurface the lower electrode. This allows for smoother and more accurate performance of the dresser.

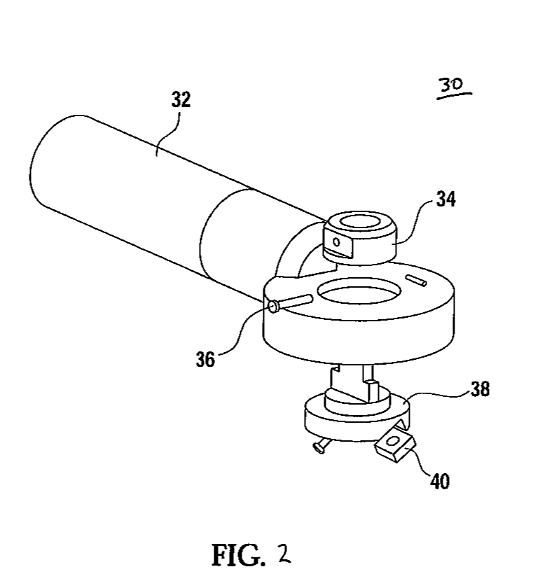

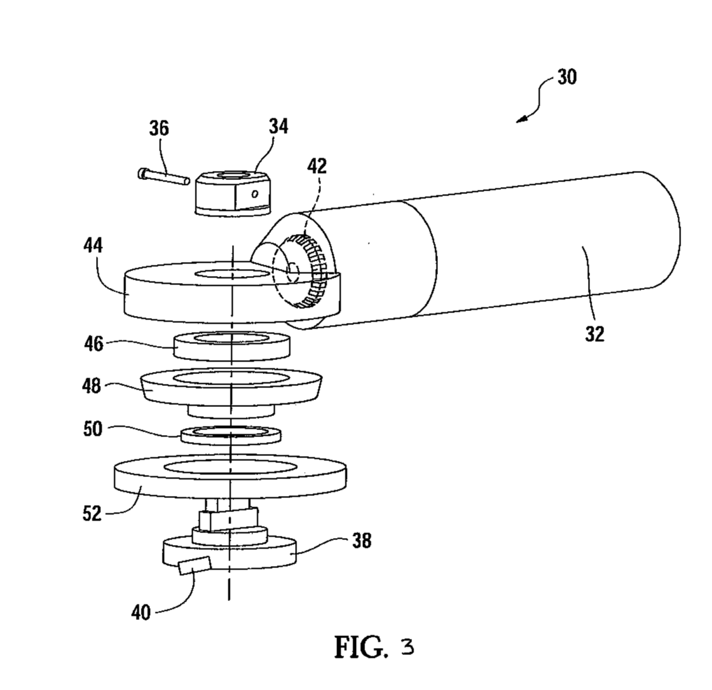

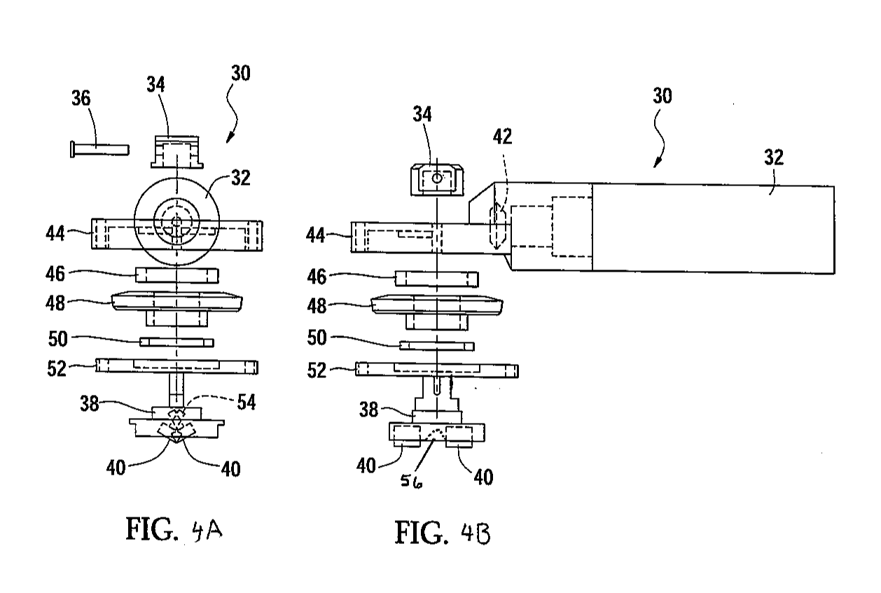

FIG. 2 shows a perspective view of a lower electrode dresser 30 in accordance with one embodiment of the present invention. The dresser 30 includes an air motor 32 that powers the device. A cutting adapter 38 that contains cutting elements 40 is mounted to the dresser 30 with a retaining cap 34 and retaining pin 36. FIGS. 3, 4a and 4b show exploded perspective, front and side views respectively this embodiment of the electrode dresser 30. The interior of the dresser 30 includes a bevel pinion 42 that transfers power to the bevel gear 48 inside the gear head housing 44. The bevel gear 48 along with a roller bearing 46 and a thrust bearing 50 are held in place with a retaining cap 52.

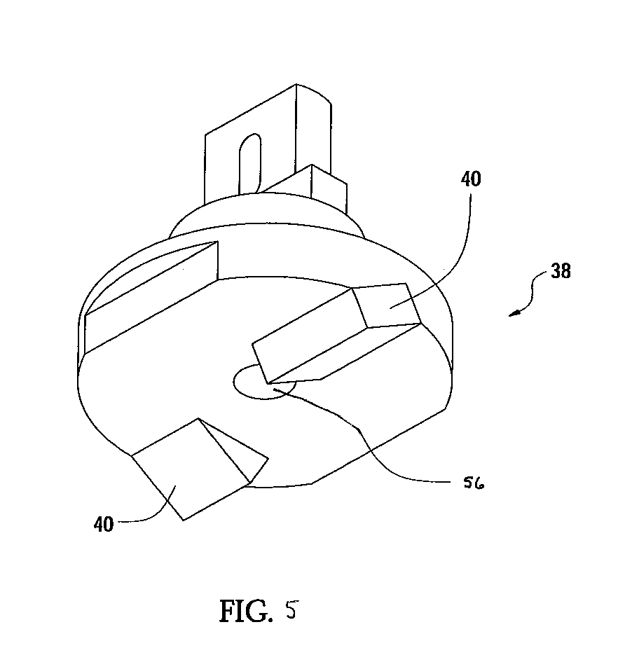

In the present embodiment, FIGS. 4a, 4b, 5, 6a, and 6b show the cutting adapter 38 that has two separate cutting elements 40. In alternative embodiments, additional cutting elements could be added to the adapter. In the embodiment shown in FIG. 4a, the cutting elements have an orientation angle 54 of 120° with respect to each other. In other embodiments, different angles could be used. FIGS. 4b, 5, 6a, and 6b show a recessed opening 56 that is located internally within the cutting adapter 38. This recessed opening 56 is a key feature of the invention because it seats over the locating pin of the lower electrode and ensure proper alignment of the dressing tool.

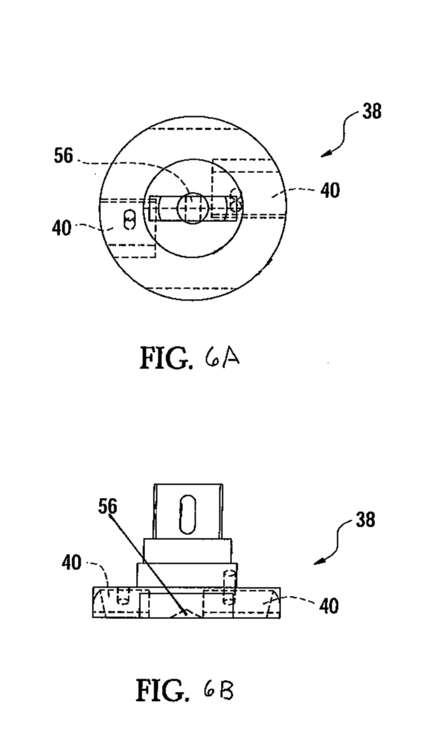

The advantage of the present invention is seen in FIGS. 4b and 6b which shows where the lower electrode's locating pin will fit inside a recessed opening 56 within the interior of the cutting adapter 38. When the dresser 30 is cutting, the lower electrode's locating pin will seat within the opening. The recessed opening 56 will be a receptacle that receives and seats the locating pin from the lower projection welding electrode. This will stabilize the dresser 30 as it rotates and cuts into the surface of the lower electrode. This provides a quicker and more efficient refurbishing of the electrode.

While certain examples of the present invention have been described in detail, it should be clear that other embodiments are possible. For example, the dresser is described as being powered by a pneumatic air motor. However, other types of motors such as electric, hydraulic, etc. could be used. Additionally, the dresser itself could be a tool that is used manually by an individual or it could be an automated part of the welder. Such an automated dresser would be used to automatically refurbish the projection welding lower electrode when the welding machine halts production.

While the invention has been described with respect to a limited number of embodiments, those skilled in the air, having benefit of this disclosure, will appreciate that other embodiments can be devised which do not depart from the scope of the invention as disclosed here. Accordingly, the scope of the invention should be limited only by the attached claims.

What is claimed is:

1. A dresser for refurbishing a projection welding lower electrode, comprising:
a rotating cutting adapter that comprises a plurality of cutting elements; and
a recessed opening within the interior of the cutting adapter that seats the adapter against a locating pin of the projection welding lower electrode in order to stabilize the rotating cutting mechanism.

2. The dresser of claim 1, where the dresser is powered by a pneumatic motor.

3. The dresser of claim 1, where the dresser is a manual tool.

4. The dresser of claim 1, where the dresser is a component of a projection welding machine.

5. The dresser of claim 1, where the rotating cutting adapter comprises two cutting elements.

6. The dresser of claim 5, where the two cutting elements are oriented at an angle of 120° with respect to each other.

7. A dresser for refurbishing a projection welding electrode, comprising:
a rotating cutting adapter that comprises a plurality of cutting elements;
means for seating the cutting elements against the projection welding electrode; and
means for stabilizing the rotating cutting adapter against a locating pin of the projection welding electrode.
